(19) United States
(12) Patent Application Publication
(10) Pub. No.: US 2019/0102202 A1
(43) Pub. Date: Apr. 4, 2019

(54) METHOD AND APPARATUS FOR DISPLAYING HUMAN MACHINE INTERFACE

(71) Applicant: GM GLOBAL TECHNOLOGY OPERATIONS LLC, Detroit, MI (US)

(72) Inventors: Ian R. Singer, Macomb, MI (US); Dominic A. Colella, Clinton Township, MI (US)

(21) Appl. No.: 15/720,068

(22) Filed: Sep. 29, 2017

(51) Int. Cl. G06F 9/44

(52) U.S. Cl. CPC G06F 9/4443

(57) ABSTRACT

A method and apparatus that generate a human machine interface are provided. The method includes detecting at least one from among a number of one or more users and a location of the one or more users, generating a human machine interface based on the at least one from among the number of the one or more users and the location of the one or more users, and outputting the generated human machine interface.

### INTRODUCTION

Apparatuses and methods consistent with exemplary embodiments relate to user interfaces. More particularly, apparatuses and methods consistent with exemplary embodiments relate to displaying a human machine interface.

### SUMMARY

One or more exemplary embodiments provide a method and an apparatus that customize a human machine interface based on a number of occupants. More particularly, one or more exemplary embodiments provide a method and an apparatus that customize a human machine interface based on a number and position of occupants and that display the customized human machine interface.

According to an exemplary embodiment, a method of generating a human machine interface is provided. The method includes detecting at least one from among a number of one or more users and a location of the one or more users, generating a human machine interface based on the at least one from among the number of the one or more users and the location of the one or more users, and outputting the generated human machine interface.

The generating the human machine interface includes selecting a number of controls of the human machine interface based on the detected number of the one or more users.

The generating the human machine interface may further include determining a location of the controls of the human machine interface based on the detected location of the one or more users.

The outputting the generated human machine interface may include displaying the generated human machine interface with the selected number of controls at the determined location of the controls on a display.

Tach of the selected controls may be configured to adjust a parameter corresponding to a location from among the determined locations of the users. The parameter may include at least one from among an audio parameter, a window parameter, a seat parameter, an illumination parameter or a climate control parameter.

The outputting the generated human machine interface may include displaying a graphic indicating a location of a user corresponding to a selected control.

The detecting at least one from among the number of users and location of the users is performed based on at least one from among image recognition performed on an image received from a camera imaging an area containing the users, information from one or more seat sensors, and information from one or more door sensors. The users may be occupants of a vehicle.

According to an exemplary embodiment, an apparatus that generates a human machine interface is provided. The apparatus includes at least one memory comprising computer executable instructions; and at least one processor configured to read and execute the computer executable instructions. The computer executable instructions may cause the at least one processor to detect at least one from among a number of one or more users and a location of the one or more users, generate a human machine interface based on the at least one from among the number of the one or more users and the location of the one or more users, and output the generated human machine interface.

The computer executable instructions may cause the at least one processor to generate the human machine interface by selecting a number of controls of the human machine interface based on the detected number of the one or more users.

The computer executable instructions may cause the at least one processor to generate the human machine interface by determining a location of the controls of the human machine interface based on the detected location of the one or more users.

The apparatus may further include a display, the computer executable instructions may cause the at least one processor to output the generated human machine interface by displaying the generated human machine interface with the selected number of controls at the determined location of the controls on the display.

Each of the selected controls may be configured to adjust a parameter corresponding to a location from among the determined locations of the users. The parameter may be at least one from among an audio parameter, a window parameter, a seat parameter, an illumination parameter or a climate control parameter.

The computer executable instructions may further cause the at least one processor to output the generated human machine interface by displaying a graphic indicating a location of a user corresponding to a selected control.

The apparatus may further include at least one from among a camera configured to provide an image of an area containing the users, a seat sensor configured to detect a presence of one or more users, and a door sensor configured to provide information on a status of a door, and the computer executable instructions may further cause the at least one processor to detect at least one from among the number of users and the location of the users based on at least one from among image recognition performed on the image received from the camera, information from the seat sensor, and information from the door sensor. The users comprise occupants of a vehicle.

According to an aspect of an exemplary embodiment, a method of generating a human machine interface is provided. The method includes: detecting a number of one or more users and a location of the one or more users, generating a human machine interface based on the number of the one or more users and the location of the one or more users, and displaying the generated human machine interface with a number of controls corresponding to the number of the one or more users and with a location of the controls on a display corresponding to the location of the one or more users.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that generates a human machine interface according to an exemplary embodiment;

FIG. 2 shows a flowchart for a method of generating a human machine interface according to an exemplary embodiment; and

FIG. 3 shows illustrations of various human machine interfaces according to aspects of exemplary embodiments.

### DETAILED DESCRIPTION OF EXEMPLARY EMBODIMENTS

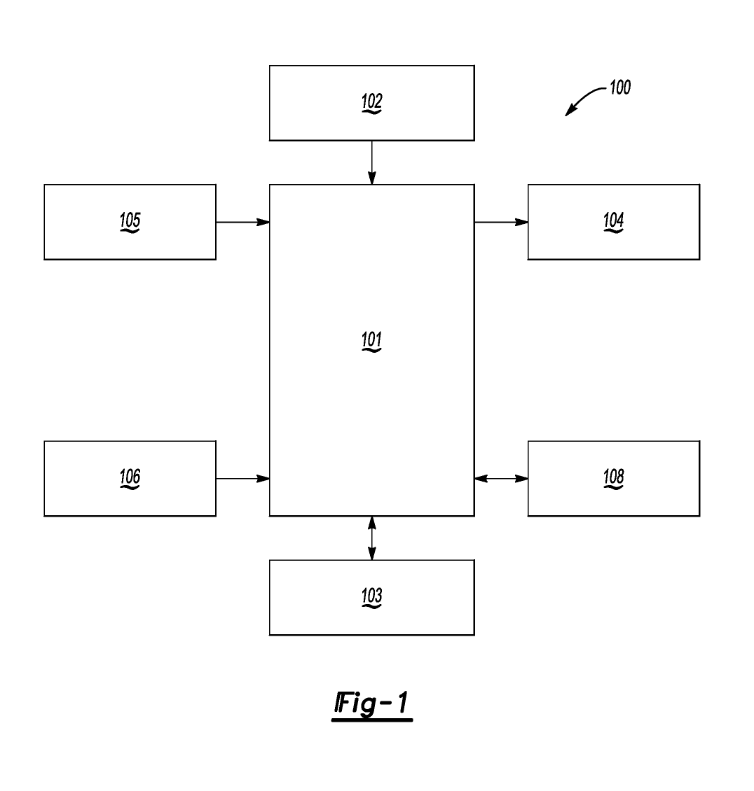

An apparatus and method that generate a human machine interface will now be described in detail with reference to FIGS. 1-3 of the accompanying drawings in which like reference numerals refer to like elements throughout the disclosure.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Human machine interfaces or user interfaces (hereinafter “HMI”) are provided in vehicles and other machines to allow an operator, occupant, or user (hereinafter “user”) to control the vehicle or machine, provide inputs to the vehicle or machine, or receive outputs from the vehicle or machine. In one example, an HMI may be used to adjust functions or settings such as audio, climate control, seating position or temperature, illumination, etc. Moreover, multiple users may desire different settings or to control different functions of a machine or vehicle. Further, providing multiple HMI's may be costly or allowing one user at a time to operate an HMI may be inconvenient. Thus, an HMI that is capable of being operated by multiple users simultaneously is desirable.

FIG. 1 shows a block diagram of an apparatus that generates an HMI 100 according to an exemplary embodiment. As shown in FIG. 1, the apparatus that generates an HMI 100, according to an exemplary embodiment, includes a controller 101, a power supply 102, a storage 103, an output 104, an occupant sensor 105, a user input 106, and a communication device 108. However, the apparatus that generates an HMI 100 is not limited to the aforementioned configuration and may be configured to include additional elements and/or omit one or more of the aforementioned elements. The apparatus that generates an HMI 100 may be implemented as part of a vehicle, as a standalone component, as a hybrid between an on vehicle and off vehicle device, or in another computing device.

The controller 101 controls the overall operation and function of the apparatus that generates an HMI 100. The controller 101 may control one or more of a storage 103, an output 104, an occupant sensor 105, a user input 106, and a communication device 108 of the apparatus that generates an HMI 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the occupant sensor 105, the user input 106, and the communication device 108 of the apparatus that generates an HMI 100. The information may be sent and received via a bus or network, or may be directly read or written to/from one or more of the storage 103, the output 104, the occupant sensor 105, the user input 106, and the communication device 108 of the apparatus that generates an HMI 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the occupant sensor 105, the user input 106, and the communication device 108 of the apparatus that generates an HMI 100. The power supply 102 may include one or more from among a battery, an outlet, a capacitor, a solar energy cell, a generator, a wind energy device, an alternator, etc.

The storage 103 is configured for storing information and retrieving information used by the apparatus that generates an HMI 100. The storage 103 may be controlled by the controller 101 to store and retrieve information received from the controller 101, the occupant sensor 105, and/or the communication device 108. The information may include information on occupants detected by the occupant sensor 105. The information may include one or more from among identification information of a user or occupant, an image of a user or occupant, information from seat sensors, information from door sensors, position information of the user or occupant, and a number of users or occupants. The storage 103 may also include the computer instructions configured to be executed by a processor to perform the functions of the apparatus that generates an HMI 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that generates an HMI 100. The output 104 may include one or more from among a speaker, an audio device, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, haptic notification, a light notification, and a display notification. The output 104 may display the generated human machine interface with the selected number of controls at the determined location of the controls. The output 104 may display one or more controls to control a volume parameter, an audio parameter, an illumination parameter or a climate control parameter.

The occupant sensor 105 is configured to provide information on one or more occupants of a space. The occupant sensor 105 may include one or more from among a heat detection sensor, an image sensor, a weight sensor, a pressure sensor, a door sensor, a laser sensor, an ultrasonic sensor, an infrared camera, a LIDAR, a radar sensor, an ultra-short range radar sensor, an ultra-wideband radar sensor, a microwave sensor and a pressure sensor. The information provided by the occupant sensor 105 may be used by the controller 101 to determine a position and number of users or occupants.

The user input 106 is configured to provide information and commands to the apparatus that generates an HMI 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a steering wheel, a touchpad, etc. The user input 106 may be configured to receive a user input to acknowledge or dismiss the notification output by the output 104.

The communication device 108 may be used by the apparatus that generates an HMI 100 to communicate with various types of external apparatuses according to various communication methods. The communication device 108 may be used to send/receive information or images taken by the occupant sensor 105. According to one example, the communication device 108 may be used to receive information used to determine a number of users or occupants and a position of the users or occupants.

The communication device 108 may include various communication modules such as one or more from among a telematics unit, a broadcast receiving module, a near field communication (NFC) module, a global navigation information receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The global navigation information receiver is a module that receives a GPS signal from a GPS satellite or other satellite or wireless signal based global positioning system and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an exemplary embodiment, the controller 101 of the apparatus that generates an HMI 100 may be configured to detect at least one from among a number of one or more users and a location of the one or more users, generate a human machine interface based on the at least one from among the number of the one or more users and the location of the one or more users, and output the generated human machine interface.

The controller 101 may be configured to generate the human machine interface by selecting a number of controls of the human machine interface based on the detected number of the one or more users.

The controller 101 may be configured to generate the human machine interface by determining a location of the controls of the human machine interface based on the detected location of the one or more users.

In one example, the controller 101 may be configured to control to output the generated human machine interface by displaying the generated human machine interface with the selected number of controls at the determined location of the controls on the display. The selected controls may be configured to adjust a parameter corresponding to a location from among the determined locations of the users. The parameter may be at least one from among an audio parameter, a window parameter, a seat parameter, an illumination parameter or a climate control parameter.

In one example, the audio parameter may be volume, channel, input, audio device, or a parameter used to control audio output. The window parameter may be used to control a window opening. The seat parameter may be used to control a temperature, position and function of a seat. The illumination parameter may be used to control a light. The climate control parameter may be used to set a temperature, fan speed, climate control setting, etc.

In another example, the controller 101 may be configured to output the generated human machine interface by displaying a graphic indicating a location of a user corresponding to a selected control.

The controller 101 may be configured to detect at least one from among the number of users and the location of the users based on at least one from among image recognition performed on the image received from the camera, information from the seat sensor, and information from the door sensor.

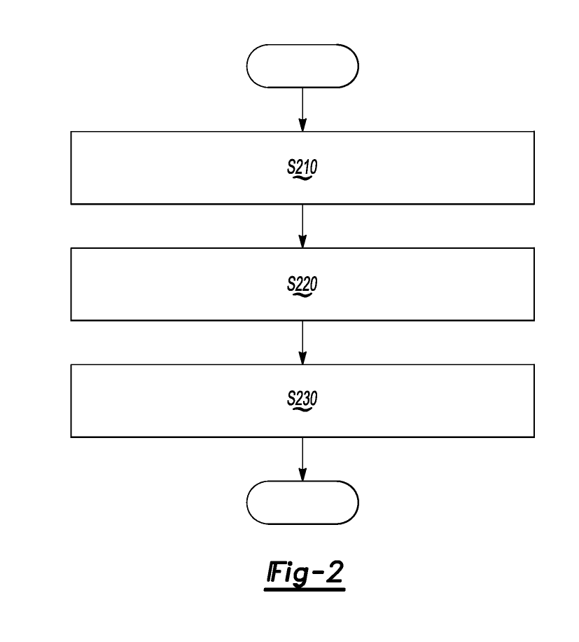

FIG. 2 shows a flowchart for a method of generating an HMI according to an exemplary embodiment. The method of FIG. 2 may be performed by the apparatus that generates an HMI 100 or may be encoded into a computer readable medium as instructions that are executable by a computer to perform the method.

Referring to FIG. 2, the presence, number and/or location of one or more users is detected in operation S210. The presence, number or location of the user or occupant may be detected in a vehicle cabin, a vehicle seat, a room, or other space that may be occupied by user or occupant.

In operation S220, an HMI is generated based on the presence, number and/or location of the one or more users. For example, the HMI can be generated a with a number of controls corresponding to the number of users, a location of the controls on a display corresponding to the location of one or more users with respect to the HMI, vehicle or machine that the user will control. Moreover, the HMI can include a graphic showing the location of the user corresponding to an interface of the HMI that controls a setting for the user represented by the graphic.

The presence of the user or occupant may be detected using one or more occupant sensors 105. In one example, information on the opening and closing of a door, information on body heat, information on weight or pressure, information from a user's personal or mobile device, or facial recognition may be used to detect the presence of the user. In yet another example, images may be taken by the occupant sensor 105 and user recognition performed on the images to determine the presence of a user in the space.

Moreover, information on the presence of a user may be combined with information on the presence of an object and used to determine that an object is associated with a user or occupant. For example, information from the object associated with the user may be received via a wireless communication signal such as Bluetooth or Wi-Fi may be used to determine the presence of a user or occupant.

In operation 230, the generated HMI may be output to the one or more users or occupants. The generated HMI may be output onto one display divided into a number of areas corresponding to the number of users. Each of the areas may include one or more of an interface and control setting corresponding to a respective user of the one or more users. In addition, each of the areas may include a graphic showing the location of a user that is intended to operate the interface, function, or control setting or include a graphic showing the area that setting, interface or control affects. In one example, the interface, function, or control setting may be disposed in a position on the display closest to a location or seat of the user intended to operate the interface, function or control setting.

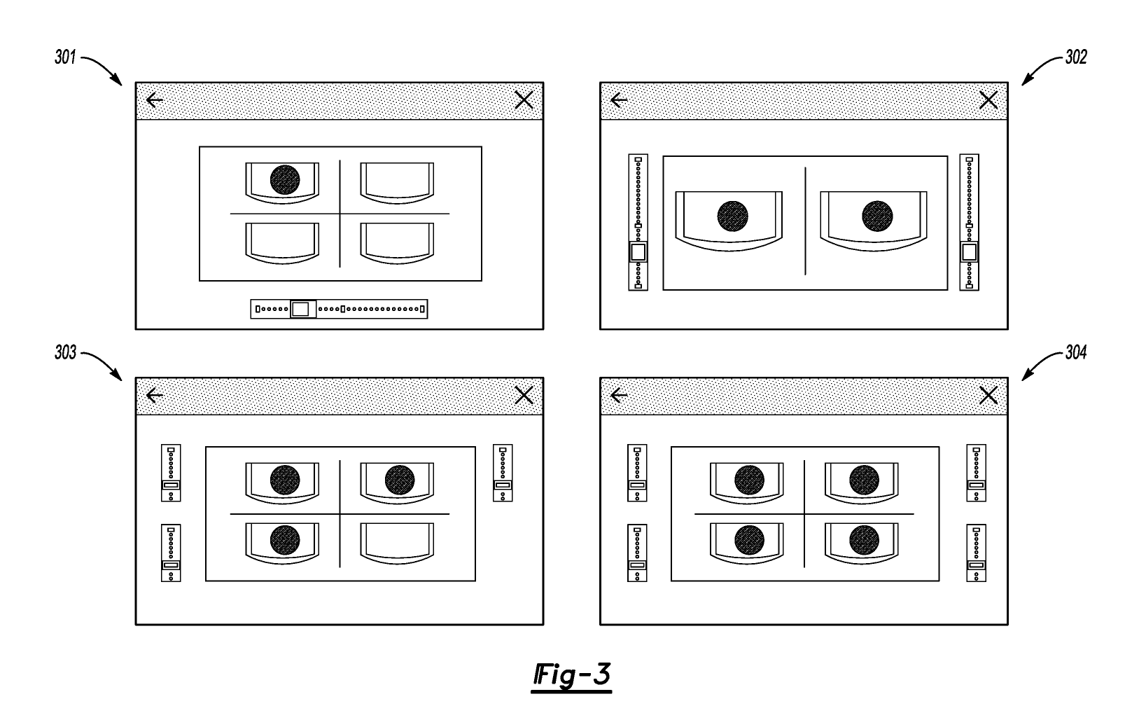

FIG. 3 shows illustrations of various human machine interfaces according to aspects of exemplary embodiments. The illustrations show examples of how the apparatus that generates an HMI may lay out controls on a display.

Referring to FIG. 3, illustration 301 shows a first example of a generated HMI. In illustration 301, the display is divided into areas corresponding to potential locations of users (e.g., seats). One user is detected in the front left seat, and thus one control that controls a setting is displayed on the display. In this case, the control is configured to control the volume for the one detected user.

Illustration 302 shows a second example of a generated HMI. In illustration 302, the display is divided into two areas corresponding to the detected number of user (i.e., two users). In addition, two controls are displayed in locations corresponding to locations of the detected two users. In this case, the controls are configured to control the volume for the respective users or for locations corresponding to the respective users

Illustration 303 shows a third example of a generated HMI. In illustration 303, the display is divided into four areas corresponding to potential locations of four potential users (e.g., seats). The locations of three detected users is indicated in three of the four areas and controls corresponding to the three detected users are displayed in three of the four areas corresponding to the detected users. In this case, the controls are configured to control the volume for the three respective users or for locations corresponding to the three respective users

Illustration 304 shows a fourth example of a generated HMI. In illustration 304, the display is divided into four areas corresponding to potential locations of four potential users (e.g., seats). The locations of four detected users is indicated in all four areas and controls corresponding to the four detected users are displayed in all four areas corresponding to the detected users.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method of generating a human machine interface, the method comprising:
detecting at least one from among a number of one or more users and a location of the one or more users;
generating a human machine interface based on the at least one from among the number of the one or more users and the location of the one or more users; and
outputting the generated human machine interface.

2. The method of claim 1, wherein the generating the human machine interface comprises selecting a number of controls of the human machine interface based on the detected number of the one or more users.

3. The method of claim 2, wherein the generating the human machine interface further comprises determining a location of the controls of the human machine interface based on the detected location of the one or more users.

4. The method of claim 3, wherein the outputting the generated human machine interface comprises displaying the generated human machine interface with the selected number of controls at the determined location of the controls on a display.

5. The method of claim 4, wherein each of the selected controls are configured to adjust a parameter corresponding to a location from among the determined locations of the users.

6. The method of claim 5, wherein the parameter comprises at least one from among an audio parameter, a window parameter, a seat parameter, an illumination parameter or a climate control parameter.

7. The method of claim 4, wherein the outputting the generated human machine interface comprises displaying a graphic indicating a location of a user corresponding to a selected control.

8. The method of claim 1, wherein the detecting at least one from among the number of users and location of the users is performed based on at least one from among image recognition performed on an image received from a camera imaging an area containing the users, information from one or more seat sensors, and information from one or more door sensors.

9. The method of claim 8, wherein the users comprise occupants of a vehicle.

10. A non-transitory computer readable medium comprising computer instructions executable by a computer to perform the method of claim 1.

11. An apparatus that generates a human machine interface, the apparatus comprising:
at least one memory comprising computer executable instructions; and
at least one processor configured to read and execute the computer executable instructions, the computer executable instructions causing the at least one processor to:
detect at least one from among a number of one or more users and a location of the one or more users;
generate a human machine interface based on the at least one from among the number of the one or more users and the location of the one or more users; and
output the generated human machine interface.

12. The apparatus of claim 11, wherein the computer executable instructions cause the at least one processor to generate the human machine interface by selecting a number of controls of the human machine interface based on the detected number of the one or more users.

13. The apparatus of claim 12, wherein the computer executable instructions cause the at least one processor to generate the human machine interface by determining a location of the controls of the human machine interface based on the detected location of the one or more users.

14. The apparatus of claim 13, further comprising a display,
wherein the computer executable instructions cause the at least one processor to output the generated human machine interface by displaying the generated human machine interface with the selected number of controls at the determined location of the controls on the display.

15. The apparatus of claim 14, wherein each of the selected controls are configured to adjust a parameter corresponding to a location from among the determined locations of the users.

16. The apparatus of claim 15, wherein the parameter comprises at least one from among an audio parameter, a window parameter, a seat parameter, an illumination parameter or a climate control parameter.

17. The apparatus of claim 14, wherein the computer executable instructions further cause the at least one processor to output the generated human machine interface by displaying a graphic indicating a location of a user corresponding to a selected control.

18. The apparatus of claim 11, further comprising at least one from among a camera configured to provide an image of an area containing the users, a seat sensor configured to detect a presence of one or more users, and a door sensor configured to provide information on a status of a door,
wherein the computer executable instructions further cause the at least one processor to detect at least one from among the number of users and the location of the users based on at least one from among image recognition performed on the image received from the camera, information from the seat sensor, and information from the door sensor.

19. The apparatus of claim 11, wherein the users comprise occupants of a vehicle.

20. A method of generating a human machine interface, the method comprising:
detecting a number of one or more users and a location of the one or more users;
generating a human machine interface based on the number of the one or more users and the location of the one or more users; and
displaying the generated human machine interface with a number of controls corresponding to the number of the one or more users and with a location of the controls on a display corresponding to the location of the one or more users.
